(19) United States
(12) Patent Application Publication
(10) Pub. No.: US 2014/0173337 A1
(43) Pub. Date: Jun. 19, 2014

(54) STORAGE APPARATUS, CONTROL METHOD, AND CONTROL PROGRAM

(71) Applicant: FUJITSU LIMITED, Kawasaki-shi (JP)

(72) Inventors: Atsushi IGASHIRA, Yokohama (JP); Hidefumi KOBAYASHI, Yokohama (JP)

(73) Assignee: FUJITSU LIMITED, Kawasaki-shi (JP)

(21) Appl. No.: 14/073,185

(22) Filed: Nov. 6, 2013

(30) Foreign Application Priority Data
Dec. 13, 2012 (JP) 2012-272769

(51) Int. Cl. G06F 11/16

(52) U.S. Cl. CPC G06F 11/1666
USPC 714/6.22

(57) ABSTRACT

A storage-apparatus has a plurality of storage-devices and a controller for controlling data read from and write to the plurality of storage-devices, the controller includes a determination-unit and a restore-processing-unit, when a new storage-device has failed in a non-redundant state being a redundant group state without redundancy, in which some of the storage-devices had failed out of the plurality of storage-devices, the determination-unit configured to determine whether execution of compulsory restore of the redundant group is possible or not on the basis of a failure cause of the plurality of failed storage-devices, and if the determination unit determines that the execution of compulsory restore of the redundant group is possible, the restore-processing-unit configured to incorporate a plurality of storage-devices including a newly failed storage-device in the non-redundant state into the redundant group and to compulsorily restore the storage-apparatus to an available state.

### CROSS-REFERENCE TO RELATED APPLICATION

This application is based upon and claims the benefit of priority of the prior Japanese Patent Application No. 2012-272769, filed on Dec. 13, 2012, the entire contents of which are incorporated herein by reference.

### FIELD

The embodiments discussed herein are related to a storage apparatus, a control method, and a control program.

### BACKGROUND

With the advent of an era of big data, techniques on “automatic hierarchization of storage”, which automatically distribute data in accordance with the characteristics of storage devices having different performances and capacities, attract attention. Accordingly, demand is increasing for inexpensive magnetic disk units with a large volume (for example, SATA-DISK of 4TB). When redundant arrays of inexpensive disks (RAID) are configured using such magnetic disk units, if a failure occurs in one unit of the magnetic disk units in operation, rebuild is carried out in a hot-spare magnetic disk unit, but it takes a long time for the rebuild. Here, rebuild is restructuring data. During rebuild, there is no redundancy of the magnetic disk units, and thus if rebuild continues for a long time, a risk of RAID failure increases.

Corruption of data files due to a RAID failure, and so on causes severe damage to a database. This is because if inconsistent data is written into a storage unit, a vast amount of workload and time become desired for identifying the cause, repairing the system, and recovering the database.

Thus, RAID compulsory restore techniques, in which when a RAID failure occurs, a RAID apparatus having the RAID failure is quickly brought back to an operable state, are known. For example, in RAIDS, when failures occur in two magnetic disk units, thus resulting in a RAID failure, if a second failed disk unit is restorable because of a temporary failure, and so on, RAID compulsory restore is carried out by restoring the second failed disk unit.

Also, techniques are known in which at the time of a RAID breakdown, RAID configuration information immediately before the breakdown is stored, and if a recovery request is given by user's operation, the RAID is compulsorily restored to the state immediately before the breakdown on the basis of the stored information (for example, refer to Japanese Laid-open Patent Publication No. 2002-373059).

Related-art techniques have been disclosed in Japanese Laid-open Patent Publication Nos. 2002-373059, 2007-52509, and 2010-134696.

However, in a RAID apparatus that has been compulsory restored, there is a problem in that no redundancy is provided, thus the occurrence of a RAID failure again is at high risk, and data assurance is insufficient.

According to an embodiment of the present disclosure, it is desirable to improve data assurance in a RAID apparatus that has been compulsory restored.

### SUMMARY

According to an aspect of the invention, a storage apparatus has a plurality of storage devices and a controller for controlling data read from the plurality of storage devices and data write to the plurality of storage devices, the controller includes a determination unit and a restore processing unit, when a new storage device has failed in a non-redundant state being a redundant group state without redundancy, in which some of the storage devices had failed out of the plurality of storage devices, the determination unit configured to determine whether execution of compulsory restore of the redundant group is possible or not on the basis of a failure cause of the plurality of failed storage devices, and if the determination unit determines that the execution of compulsory restore of the redundant group is possible, the restore processing unit configured to incorporate a plurality of storage devices including a newly failed storage device in the non-redundant state into the redundant group and to compulsorily restore the storage apparatus to an available state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a RAID apparatus according to an embodiment;

FIG. 2 is a diagram illustrating a functional configuration of an input/output control program executed on a CPU;

FIG. 3 is a diagram illustrating an example of slice_bitmap;

FIG. 4 is a diagram illustrating an example of a RAID state that is not allowed to be restored by a RAID compulsory restore function;

FIG. 5A is a flowchart illustrating a processing flow of processing for performing RAID compulsory restore only on the last disk;

FIG. 5B is a flowchart illustrating a processing flow of processing for performing RAID compulsory restore on the last disk and first disk;

FIG. 6 is a diagram illustrating state transition of a RAID apparatus (RLU state);

FIG. 7 is a flowchart illustrating a processing flow of write-back processing in the case where the state of the RAID apparatus is “EXPOSED”;

FIG. 8 is a flowchart illustrating a processing flow of staging processing after RAID compulsory restore;

FIG. 9 is a diagram illustrating an example of the staging processing after RAID compulsory restore;

FIG. 10 is a flowchart illustrating a processing flow of write-back processing after RAID compulsory restore;

FIG. 11 is a diagram for describing kinds of write back; and

FIG. 12 is a diagram illustrating an example of write-back processing after RAID compulsory restore.

### DESCRIPTION OF EMBODIMENT

In the following, a detailed description is given of a storage apparatus, a control method, and a control program according to an embodiment of the present disclosure with reference to the drawings. In this regard, this embodiment does not limit the disclosed technique.

### Embodiment

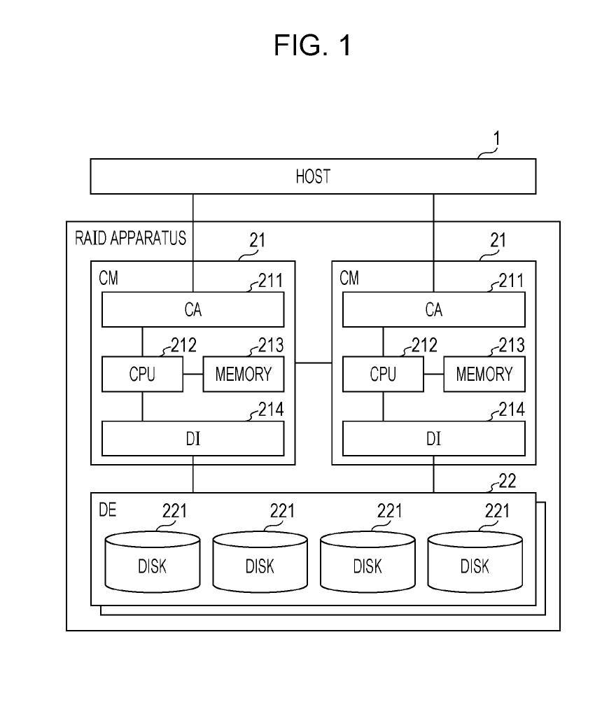

First, a description is given of a RAID apparatus according to the embodiment. FIG. 1 is a diagram illustrating a configuration of a RAID apparatus according to the embodiment. As illustrated in FIG. 1, a RAID apparatus 2 includes two control modules (CM) 21 constituting a redundant system, and a device enclosure (DE) 22.

The CM 21 is a controller that controls data read from the RAID apparatus 2, and data write to the RAID apparatus 2, and includes a channel adapter (CA) 211, a CPU 212, a memory 213, and a device interface (DI) 214. The CA 211 is an interface with a host 1, which is a computer using the RAID apparatus 2, and accepts an access request from the host 1, and makes a response to the host 1. The CPU 212 is a central processing unit that controls the RAID apparatus 2 by executing an input/output control program stored in the memory 213. The memory 213 is a storage device for storing the input/output control program to be executed on the CPU 212 and data. The DI 214 is an interface with the DE 22, and instructs the DE 22 to read and write data.

The DE 22 includes four disks 221, and stores data to be used by the host 1. In this regard, here, a description is given of the case where the DE 22 includes four disks 221, and constitutes RAIDS (3+1), that is to say, the case where three units store data for each stripe, and one unit stores parity data. However, the DE 22 may include the disks 221 of other than four units. The disk 221 is a magnetic disk unit that uses a magnetic disk as a data recording medium.

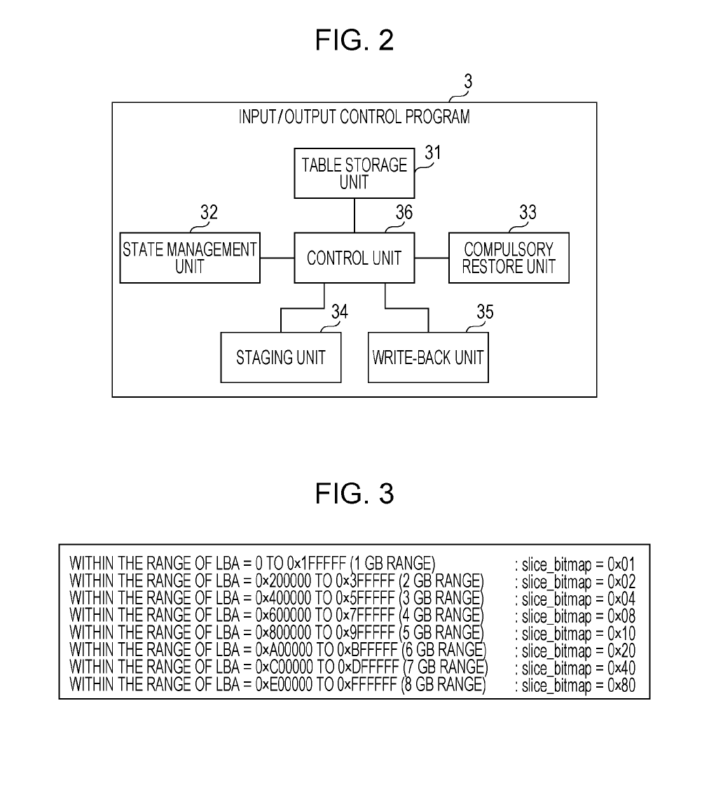

Next, a description is given of a functional configuration of an input/output control program executed on the CPU 212. FIG. 2 is a diagram illustrating a functional configuration of the input/output control program executed on the CPU. As illustrated in FIG. 2, an input/output control program 3 includes a table storage unit 31, a state management unit 32, a compulsory restore unit 33, a staging unit 34, a write-back unit 35, and a control unit 36.

The table storage unit 31 is a storage unit that stores data desired for controlling the RAID apparatus. The data stored in the table storage unit 31 is stored in the memory 213 illustrated in FIG. 1. Specifically, the table storage unit 31 stores RLU_TBL which stores information on the RAID apparatus 2, such as a state of the apparatus, a RAID level, and so on, and PLU_TBL which stores information on disks, such as a state of the unit, a capacity, and so on.

Also, the table storage unit 31 stores information on slice_bitmap as SLU_TBL. Here, slice_bitmap is information indicating an area into which data is written in a state in which the RAID apparatus 2 lost redundancy, and represents a state of a predetermined-size area specified by logical block address (LBA) by one bit.

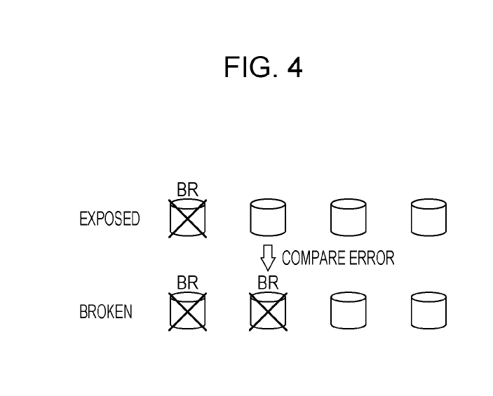

FIG. 3 is a diagram illustrating an example of slice_bitmap, and illustrates the case of using one-byte slice_bitmap for one volume=0 to 0x1000000LBA (8 GB). For example, the least significant bit of slice_bitmap is assigned to 1 GB in the range whose LBA=0 to 0x1FFFFF, and the most significant bit of slice_bitmap is assigned to 1 GB in the range whose LBA=0xE00000 to 0xFFFFFF. In this regard, a numeric character string having beginning characters of 0x denotes a hexadecimal number. Also, a bit value “1” of slice_bitmap indicates that data has been written into a corresponding area in a state in which the RAID apparatus 2 is without redundancy. A bit value “0” of slice_bitmap indicates that data has not been written into a corresponding area in a state in which the RAID apparatus 2 is without redundancy. Also, here, a description has been given of the case of using one-byte slice_bitmap. However, in the case of using four-byte slice_bitmap, it becomes possible to divide the entire area into 32 equal parts to manage the area.

The state management unit 32 detects a failure in the disk 221 and the RAID apparatus 2, and manages the disk 221 and the RAID apparatus 2 using PLU_TBL and RLU_TBL. The states managed by the state management unit 32 includes “AVAILABLE”, which indicates an available state with redundancy, “BROKEN”, which indicates a failed state, and “EXPOSED”, which indicates a state without redundancy. Also, the states managed by the state management unit 32 include, “TEMPORARY_USE”, which indicates a RAID compulsory restore state, and so on. Also, when the state management unit 32 changes the state of the RAID apparatus 2, the state management unit 32 sends a configuration change notification to the write-back unit 35.

When the RAID apparatus 2 becomes a failed state, that is to say, when the state of the RAID apparatus 2 becomes “BROKEN”, the compulsory restore unit 33 determines whether the first disk and the last disk are restorable. If restorable, the compulsory restore unit 33 performs compulsory restore on both of the disks. Here, the “first disk ” is a disk that has failed first from the state in which all the disks 221 are normal, and is also referred to as a suspected disk. Also, the “last disk” is a newly failed disk when there is no redundancy in the RAID apparatus 2, and if the last disk fails, the RAID apparatus 2 becomes a failed state. In RAIDS, if two disks fail, the RAID apparatus 2 becomes the failed state, and thus a disk that has failed in the second place is the last disk.

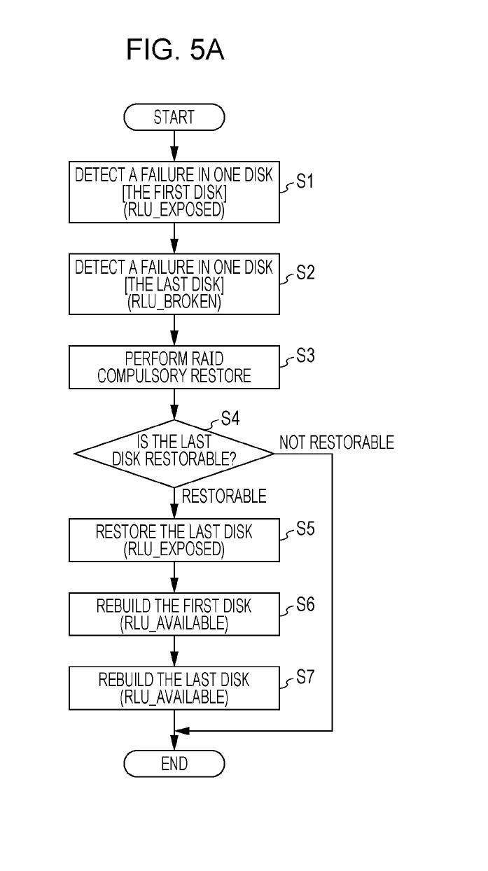

FIG. 4 is a diagram illustrating an example of a RAID state that is not allowed to be restored by a RAID compulsory restore function. In FIG. 4, “BR” indicates that the state of the disk is “BROKEN”. FIG. 4 illustrates that in RAIDS, when one disk fails, and the RAID apparatus 2 is in the state of “EXPOSED”, if a second disk fails with a compare error, a compulsory restore of the RAID apparatus 2 is not possible. Here, the compare error is an error that is discovered by writing predetermined data into a disk, then reading that data, and comparing the data with the written data.

In the case of a failure caused by a hardware factor, such as a compare error, it is not possible for the compulsory restore unit 33 to perform RAID compulsory restore. On the other hand, in the case of a transient failure, such as an error caused by a temporarily high load on a disk, and so on, the compulsory restore unit 33 performs RAID compulsory restore. In this regard, when the compulsory restore unit 33 performs RAID compulsory restore, the compulsory restore unit 33 changes the state of the RAID apparatus 2 to “TEMPORARY_USE”.

The staging unit 34 reads data stored in the RAID apparatus 2 on the basis of a request from the host 1. However, if the state of the RAID apparatus 2 is a state in which RAID compulsory restore has been performed, the staging unit 34 checks the value of slice_bitmap corresponding to the area from which data read is requested before the RAID apparatus 2 reads the stored data.

And if the value of slice_bitmap is “0”, the area is not an area into which data has been written when the RAID apparatus 2 lost redundancy, and thus the staging unit 34 reads the requested data from the disk 221 to respond to the host 1.

On the other hand, if the value of slice_bitmap is “1”, the staging unit 34 reads the requested data from the disk 221 to respond to host 1, and performs data consistency processing with the area from which the data has been read. That is to say, the staging unit 34 performs data consistency processing on the area into which data was written when the RAID apparatus 2 lost redundancy. Specifically, the staging unit 34 updates the data of the suspected disk to the latest data as to the area into which data is written when the RAID apparatus 2 lost redundancy using the data of the other disk for each stripe. This is because the suspected disk is a failed disk in the first place, and thus old data is stored in the area into which data was written when the RAID apparatus 2 lost redundancy. In this regard, a description is given later of the details of the processing flow of the data inconsistency processing by the staging unit 34.

The write-back unit 35 writes data into the RAID apparatus 2 on the basis of a request from the host 1. However, if the RAID apparatus 2 is in a state without redundancy, the write-back unit 35 sets the bit corresponding to the data write area among the bits of slice_bitmap to “1”.

Also, if it is desired to read data from the disk 221 in order to calculate a parity at the time of writing the data, the write-back unit 35 performs data consistency processing on the area into which data has been written when the RAID apparatus 2 lost redundancy. A description is given later of the details of the processing flow of the data inconsistency processing by the write-back unit 35.

The control unit 36 is a processing unit that performs overall control of the input/output control program 3. Specifically, the control unit 36 performs transfer of control among the functional units and data exchange between the functional units and the storage units, and so on so as to function the input/output control program 3 as one program.

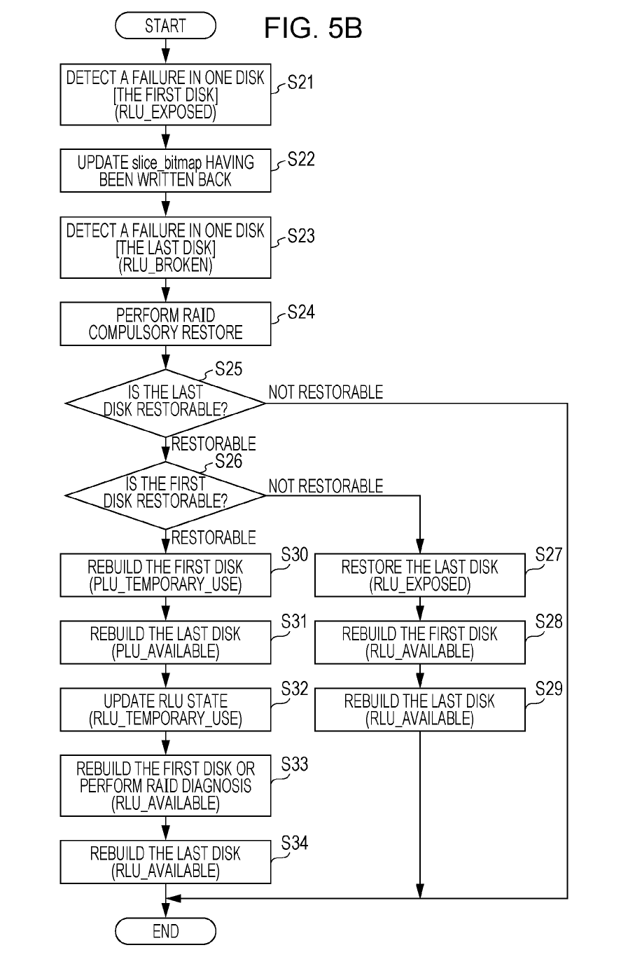

Next, a description is given of a processing flow of processing for performing RAID compulsory restore using FIG. 5A and FIG. 5B. FIG. 5A is a flowchart illustrating a processing flow of processing for performing RAID compulsory restore only on the last disk. FIG. 5B is a flowchart illustrating a processing flow of processing for performing RAID compulsory restore on the last disk and first disk.

As illustrated in FIG. 5A, the RAID apparatus detects a failure in one disk, that is to say, a failure of the first disk, and sets the state of the RAID apparatus to “RLU_EXPOSED” (operation S1). After that, the RAID apparatus detects a failure of another disk, that is to say, a failure of the last disk, and sets the state of the RAID apparatus to “RLU_BROKEN” (operation S2).

And the RAID apparatus performs RAID compulsory restore (operation S3). That is to say, the RAID apparatus determines whether the last disk is restorable or not (operation S4). If not restorable, the processing is terminated with keeping the RAID failure as it is. On the other hand, if restorable, the RAID apparatus restores the last disk, and the state of the RAID apparatus is set to “RLU_EXPOSED” (operation S5).

After that, when the first disk is replaced, the RAID apparatus rebuilds the first disk, and sets the state to “RLU_AVAILABLE” (operation S6). And when the last disk is replaced, the RAID apparatus rebuilds the last disk, and sets the state to “RLU_AVAILABLE” (operation S7). Here, the reason that the RAID apparatus sets the state of to “RLU_AVAILABLE” again is to change the state during the rebuild.

On the other hand, in the processing for performing RAID compulsory restore on the last disk and the first disk, as illustrated in FIG. 5B, the RAID apparatus 2 detects a failure in one disk 221, that is to say, detects a failure in the first disk. And the RAID apparatus 2 sets the state to “RLU_EXPOSED” (operation S21). And when write-back is performed in the state of “RLU_EXPOSED”, the RAID apparatus 2 updates a bit corresponding to the area that has been written back among the bits of slice_bitmap (operation S22).

After that, the RAID apparatus 2 detects a failure in another disk 221, that is to say, a failure in the last disk, and sets the state of the RAID apparatus 2 to “RLU_BROKEN” (operation S23).

And the RAID apparatus 2 performs RAID compulsory restore (operation S24). That is to say, the RAID apparatus 2 determines whether the last disk is restorable or not (operation S25), and if not restorable, the processing is terminated with keeping the RAID failure as it is.

On the other hand, if restorable, the RAID apparatus 2 determines whether the first disk is restorable or not (operation S26). If not restorable, the RAID apparatus 2 restores the last disk, and sets the state to “RLU_EXPOSED” (operation S27). After that, when the first disk is replaced, the RAID apparatus 2 rebuilds the first disk, and sets the state to “RLU_AVAILABLE” (operation S28). And if the last disk is replaced, the RAID apparatus 2 rebuilds the last disk, and sets the state to “RLU_AVAILABLE” (operation S29). Here, the reason that the RAID apparatus 2 sets to “RLU_AVAILABLE” again is to change the state during the rebuild.

On the other hand, if the first disk is restorable, the RAID apparatus 2 restores the first disk, and sets the state of the first disk to “PLU_TEMPORARY_USE” (operation S30). And the RAID apparatus 2 restores the last disk, and sets the state of the last disk to “PLU_AVAILABLE” (operation S31). And the RAID apparatus 2 sets the state of the apparatus to “RLU_TEMPORARY_USE” (operation S32).

After that, when the first disk is replaced, the RAID apparatus 2 rebuilds the first disk. Alternatively, the RAID apparatus 2 performs RAID diagnosis (operation S33). And the RAID apparatus 2 sets the state to (RLU_AVAILABLE). And when the last disk is replaced, the RAID apparatus 2 rebuilds the last disk, and sets the state to (RLU_AVAILABLE) (operation S34). Here, the reason that the RAID apparatus 2 sets to “RLU_AVAILABLE” again is to change the state during the rebuild.

In this manner, by determining whether the first disk and the last disk are restorable or not, and restoring both of the disks if restorable, it is possible for the RAID apparatus 2 to perform RAID compulsory restore with redundancy.

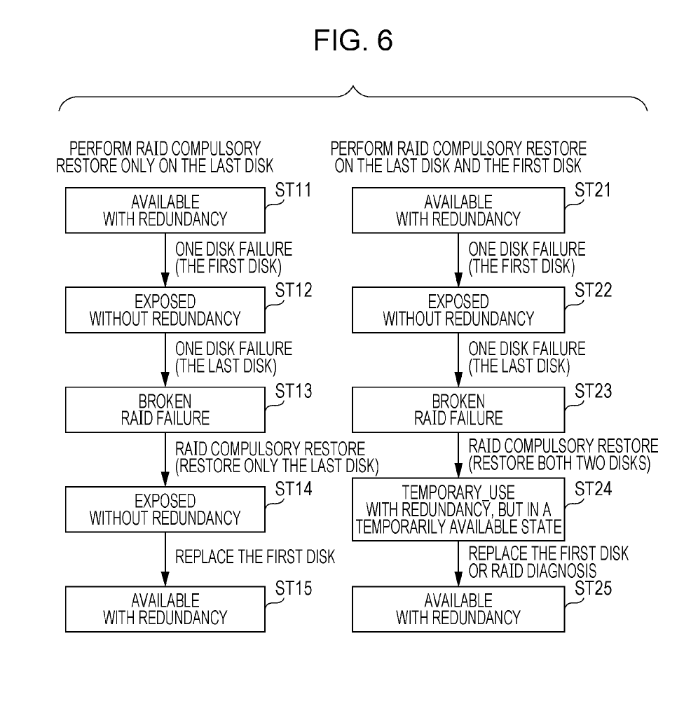

Next, a description is given of state transition of the RAID apparatus. FIG. 6 is a diagram illustrating state transition of a RAID apparatus (RLU state). As illustrated in FIG. 6, in the case of performing RAID compulsory restore only on the last disk, when all the disks are operating normally, the state of the RAID apparatus is “AVAILABLE”, which is a state with redundancy (ST11). And if one disk, that is to say, the first disk fails, the state of the RAID apparatus is changed to “EXPOSED”, which is a state without redundancy (ST12).

After that, when another disk, that is to say, the last disk fails, the state of the RAID apparatus is changed to “BROKEN”, which indicates a failed state (ST13). And if the last disk is restored by RAID compulsory restore, the state of the RAID apparatus is changed to “EXPOSED”, which is a state without redundancy (ST14). After that, if the first disk is replaced, the state of the RAID apparatus is changed to “AVAILABLE” which is a state with redundancy (ST15).

On the other hand, in the case of performing RAID compulsory restore on the last disk and the first disk, when all the disks 221 are normally operating, the state of the RAID apparatus 2 is “AVAILABLE”, which is a state with redundancy (ST21). And if one disk 211, that is to say, the first disk fails, the state of the RAID apparatus is changed to “EXPOSED”, which is a state without redundancy (ST22).

After that, when another disk 221, that is to say, the last disk fails, the state of the RAID apparatus 2 is changed to “BROKEN”, which indicates a failed state (ST23). And if the last disk and the first disk are restored by RAID compulsory restore, the state of the RAID apparatus 2 is changed to “TEMPORARY_USE”, which is a state with redundancy and allowed to be used temporarily (ST24). After that, if the first disk is replace or RAID diagnosis is performed, the state of the RAID apparatus 2 is changed to “AVAILABLE”, which is a state with redundancy (ST25).

In this manner, by restoring the last disk and the first disk by RAID compulsory restore to change the state to “TEMPORARY_USE”, it is possible for the RAID apparatus 2 to operate in a state with redundancy after RAID compulsory restore.

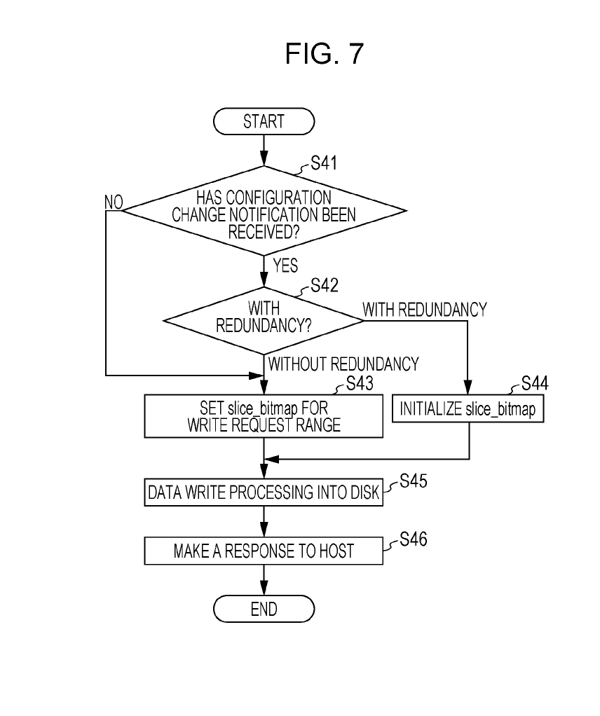

Next, a description is given of a processing flow of write-back processing when the state of the RAID apparatus 2 is “EXPOSED”. FIG. 7 is a flowchart illustrating a processing flow of write-back processing in the case where the state of the RAID apparatus 2 is “EXPOSED”.

As illustrated in FIG. 7, the write-back unit 35 determines whether a configuration change notification has been received or not after the previous write-back processing (operation S41). As a result, if a configuration change notification has not been received, the state of the RAID apparatus 2 is kept as “EXPOSED”, and the write-back unit 35 proceeds to operation S43. On the other hand, if a configuration change notification has been received, there has been a change of the state of the RAID apparatus 2, and thus the write-back unit 35 determines whether the RAID apparatus 2 has redundancy or not (operation S42).

As a result, if there is redundancy, the state of the RAID apparatus has not been “EXPOSED”, and thus the write-back unit 35 initializes slice_bitmap (operation S44). On the other hand, if there is no redundancy, the write-back unit 35 sets the bit of slice_bitmap corresponding to the write request range to “1” (operation S43).

And the write-back unit 35 performs data write processing on the disk 221 (operation S45), and makes a response of the result to the host 1 (operation S46).

In this manner, when the state of the RAID apparatus 2 is “EXPOSED”, the write-back unit 35 sets the corresponding bit of slice_bitmap of the write request range to “1”, and thus it is possible for the RAID apparatus 2 to identify a target area of the data consistency processing in the state of RAID compulsory restore.

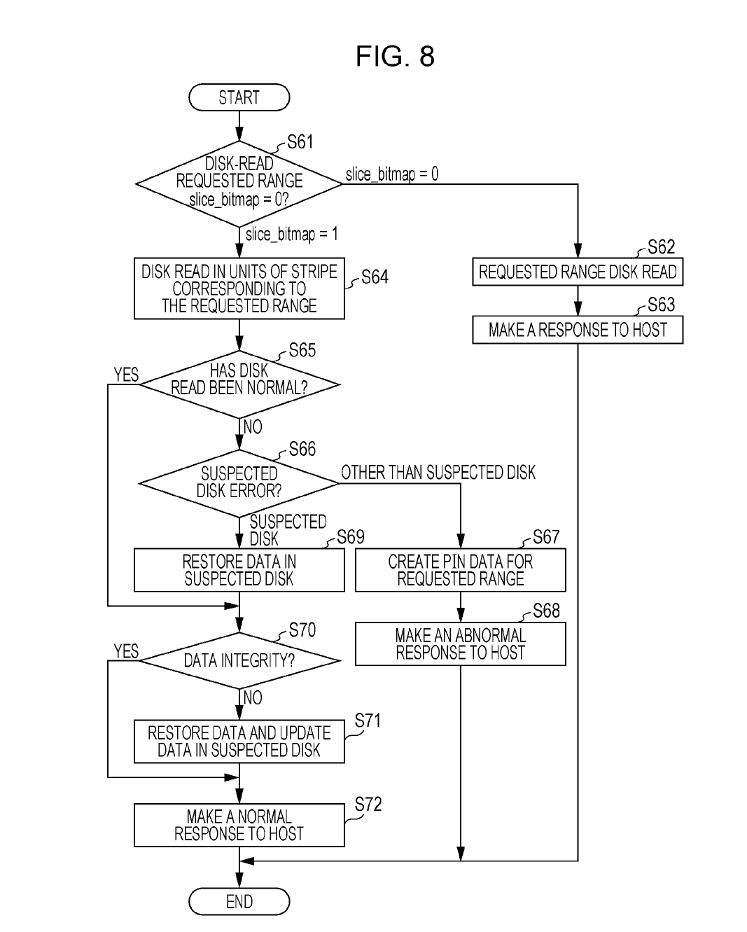

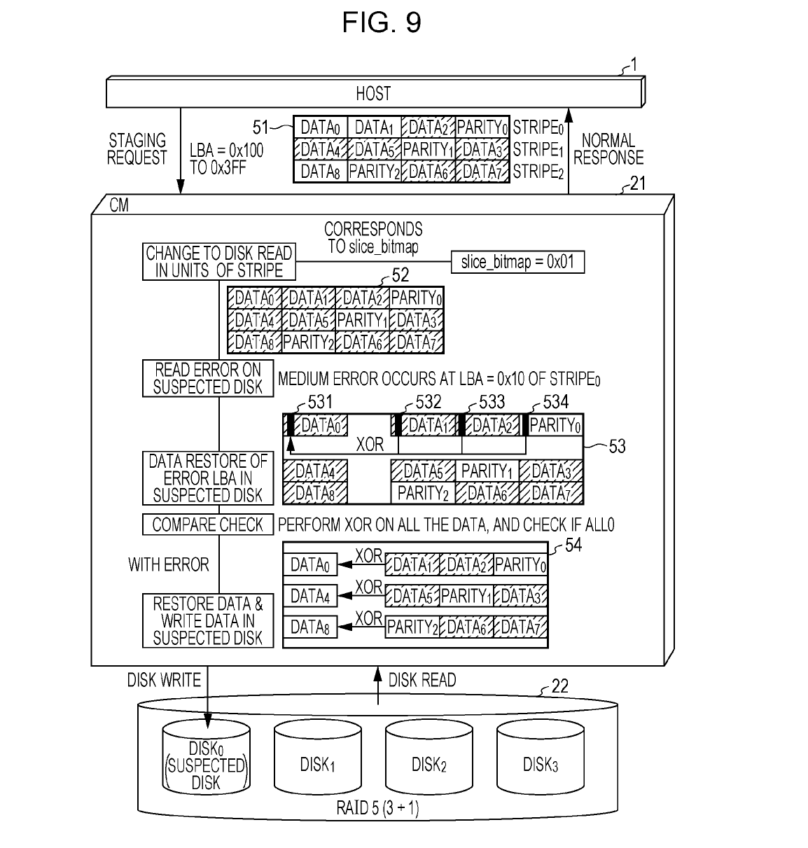

Next, a description is given of a processing flow of staging processing after RAID compulsory restore using FIG. 8 and FIG. 9. Here, the staging processing after RAID compulsory restore is staging processing when the state of the RAID apparatus 2 is “RLU_TEMPORARY_USE”.

FIG. 8 is a flowchart illustrating a processing flow of staging processing after RAID compulsory restore. FIG. 9 is a diagram illustrating an example of the staging processing after RAID compulsory restore. As illustrated in FIG. 8, the staging unit 34 determines whether value of slice_bitmap in the disk-read request range is “0” or “1” (operation S61).

As a result, if the value of slice_bitmap is “0”, the disk-read request range is not an area into which the RAID apparatus 2 performed data write in the state without redundancy, and thus the staging unit 34 performs disk read of the requested range in the same manner as before (operation S62). And the staging unit 34 makes a response of the read result to the host 1 (operation S63).

On the other hand, if the value of slice_bitmap is “1”, the disk-read request range is an area into which the RAID apparatus 2 performed data write in the state without redundancy, and thus the staging unit 34 performs disk read for each stripe corresponding to the requested range (operation S64).

For example, in FIG. 9, it is assumed that when the host 1 makes a staging request in the range LBA=0x100 to 0x3FF, data was stored in four disks, namely disk₀ to disk₃ in the form of three stripes, namely stripe₀ to stripe₂ as storage data 51. Here, out of the storage data 51, data₀, data₄, and data₈ are stored in disk₀, which is the suspected disk, data₁, data₅, and parity₂ are stored in disk₁, data₂, parity₁, and data₆ are stored in disk₂, and parity₀, data₃, and data₇ are stored in disk₃.

Also, it is assumed that a shaded portion of the storage data 51 is data corresponding to LBA=0x100 to 0x3FF. Also, assuming that slice_bitmap=0x01, from FIG. 3, an area in the range LBA=0x100 to 0x3FF was an area into which data is written in a state in which the RAID apparatus 2 lost redundancy, and thus three stripes of data are all read as read data 52. That is to say, an unshaded portion of the storage data 51, namely data₀, data₁, and data₈ are read together with the parity data and the other data.

And the staging unit 34 determines whether disk read is normal or not (operation S65). If normal, the processing proceeds to operation S70. On the other hand, if not normal, the staging unit 34 determines whether a suspected disk error has occurred or not (operation S66). As a result, in the case of an error other than the suspected disk, it is not possible to assure the data, the staging unit 34 creates PIN data for the requested range (operation S67), and makes an abnormal response to the host 1 together with the PIN data (operation S68). Here, the PIN data is data indicating data inconsistency.

On the other hand, if the suspected disk error, the staging unit 34 restores the data of the suspected disk from the other data and the parity data (operation S69). That is to say, the target area is an area into which the RAID apparatus 2 has written data in a state without redundancy, and thus the suspected disk might not store the latest data. Thus, the staging unit 34 updates the data of the suspected disk to the latest data.

For example, in FIG. 9, in error-occurred data 53, an error part 531 corresponding to the error-occurred LBA=0x10 in data 0 is restored from the corresponding parts 532, 533, and 534 in the other data₁ and data₂, which are used for parity generation, and parity₀. Specifically, the staging unit 34 generates the data of the error part 531 by performing an exclusive-OR operation on the data of the corresponding part 532, 533, and 534 in data₁, data₂, and parity₀.

And the staging unit 34 determines whether there is data consistency or not by performing compare check (operation S70). Here, the compare check is checking whether all the bits of the result of performing exclusive-OR operation on all the data for each stripe are 0 or not. For example, in FIG. 9, a determination is made of whether all the bits of the result of performing exclusive-OR operation on data₀, data₁, data₂, and parity₀ are 0 or not.

And if there is not data consistency, the staging unit 34 restores the data of the suspected disk from the other data and the parity data in the same stripe, and updates the suspected disk (operation S71). For example, in FIG. 9, in the restored data 54, the result of the exclusive-OR operation on data₁, data₂, and parity₀ is data₀, and the result of the exclusive-OR operation on data₅, parity₁, and data₃ is data₄. Also, the result of the exclusive-OR operation on parity₂, data₆, and data₇ is data₈.

And the staging unit 34 sends a normal response to the host 1 together with the data (operation S72).

In this manner, if a read area is an area into which data has been written in a state in which the RAID apparatus 2 lost redundancy, by the staging unit 34 performing matching processing of the suspected disk, it is possible for the RAID apparatus 2 to assure the data at higher level.

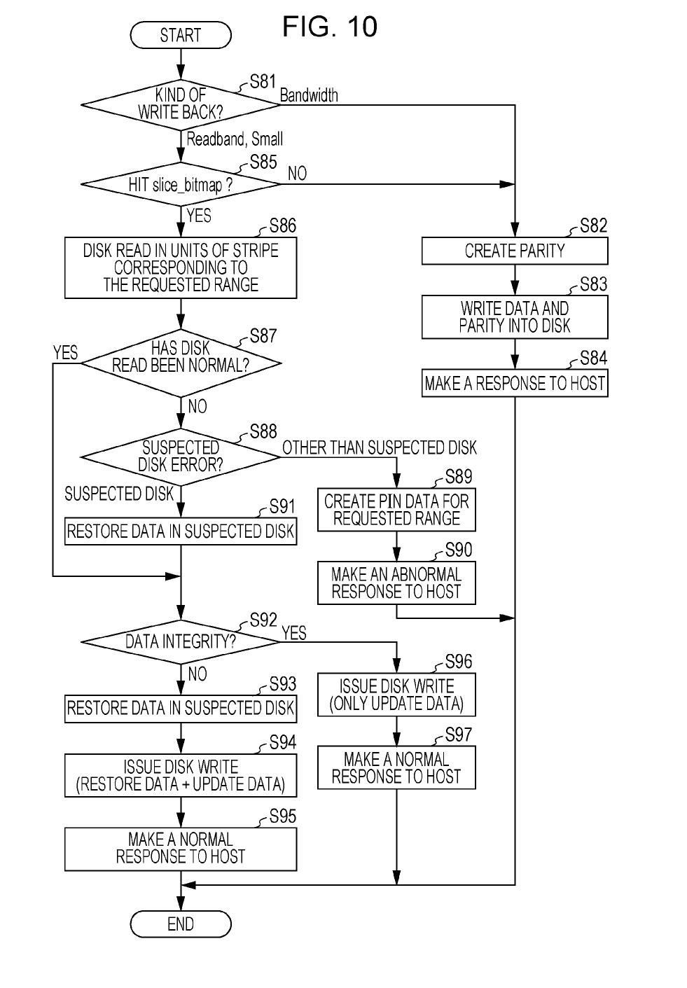

Next, a description is given of the processing flow of write-back processing after RAID compulsory restore using FIG. 10 to FIG. 12. Here, the write-back processing after RAID compulsory restore is write-back processing when the state of the RAID apparatus 2 is “RLU_TEMPORARY_USE”.

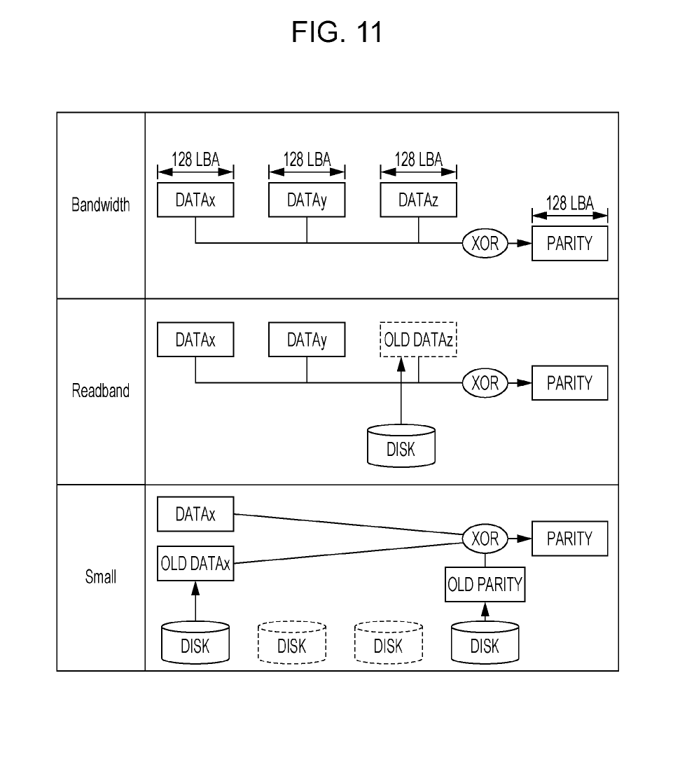

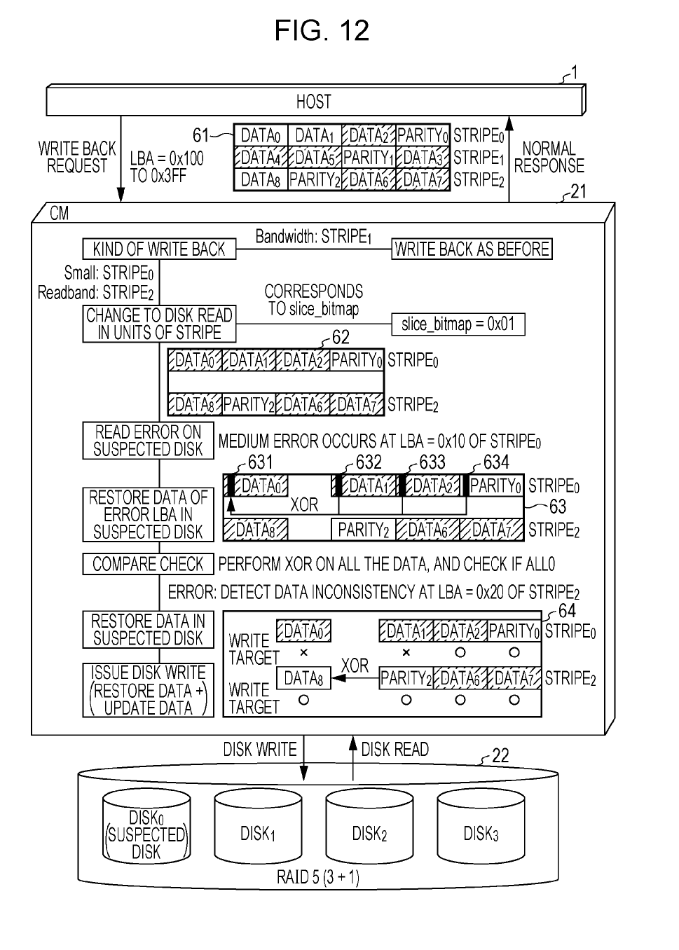

FIG. 10 is a flowchart illustrating the processing flow of write-back processing after RAID compulsory restore. FIG. 11 is a diagram for describing kinds of write back. And FIG. 12 is a diagram illustrating an example of write-back processing after RAID compulsory restore. As illustrated in FIG. 10, the write-back unit 35 determines a kind of write-back (operation S81). Here, as illustrates in FIG. 11, the kinds of write-back include “Bandwidth”, “Readband”, and “Small”.

“Bandwidth” is the case where data to be written into the disk has a sufficiently large size for parity calculation, and the case where it is not desired to read data from the disk for parity calculation. For example, as illustrated in FIG. 11, there are data x, data y, and data z whose size is 128 LBA for write data, and the parity is calculated from data x, data y, and data z.

“Readband” is the case where the size of the data to be written into the disk is insufficient for parity calculation, and it is desired to read data from the disk for parity calculation. For example, as illustrated in FIG. 11, there are data x and data y having a size of 128 LBA for write data, and old data z is read from the disk to calculate the parity.

“Small” is the case where the size of the data to be written into the disk is insufficient for parity calculation in the same manner as “Readband”, and it is desired to read data from the disk for parity calculation. However, if the size of data to be written into the disk is 50% or more of the data desired for parity calculation, the write-back processing is “Readband”, and if the size of data to be written into the disk is less than disk 50% of the data desired for parity calculation, the write-back processing is “Small”. For example, as illustrated in FIG. 11, if there is data x having a size of 128 LBA for write data, the parity is calculated from data x to be written and the old data x and the old parity in the disk.

Referring back to FIG. 10, if the kind of write-back is “Bandwidth”, it is not desired to read data from the disk, the write-back unit 35 creates parity in the same manner as before (operation S82). And the write-back unit 35 writes the data and the parity into the disk (operation S83), and makes a response to the host 1 (operation S84).

On the other hand, if the kind of write-back is not “Bandwidth”, the write-back unit 35 determines whether slice_bitmap of the disk-write requested range of is hit, that is to say, whether the value of slice_bitmap is “0” or “1” (operation S85).

As a result, if slice_bitmap is not hit, that is to say, if the value of slice_bitmap is “0”, the disk-write requested range is not an area into which data is written in a state in which the RAID apparatus 2 lost redundancy, and thus the write-back unit 35 performs the same processing as before. That is to say, the write-back unit 35 creates a parity (operation S82), writes the data and the parity into the disk (operation S83), and makes a response to the host 1 (operation S84).

On the other hand, if slice_bitmap is hit, the write-back requested range is an area into which data is written in a state in which the RAID apparatus 2 lost redundancy, and thus the write-back unit 35 performs disk read for each stripe corresponding to the requested range (operation S86). Here, the case where slice_bitmap is hit is the case where the value of slice_bitmap is “1”.

For example, in FIG. 12, it is assumed that when the host 1 makes a write-back request in the range of LBA=0x100 to 0x3FF, the data was stored in four disks, namely disk₀ to disk₃ in the form of three stripes, namely stripe₀ to stripe₂ as storage data 61. Here, it is assumed that the kind of write-back in stripe₀ is “Small”, the kind of write-back in stripe₁ is “Bandwith”, and the kind of write-back in stripe₂ is “Readband”. Also, out of storage data 61, data₀, data₄, and data₈ are stored in disk 0, which is a suspected disk, data₁, data₅, and parity₂ are stored in disk₁, data₂, parity₁, and data₆ are stored in disk₂, and parity₀, data₃, and data₇ are stored in disk₃.

Also, it is assumed that a shaded portion of the storage data 61 is data corresponding to LBA=0x100 to 0x3FF. Also, assuming that slice_bitmap=0x01, from FIG. 3, an area in the range of LBA=0x100 to 0x3FF was an area into which data is written in a state in which the RAID apparatus 2 lost redundancy, and thus, data of stripe₀ and stripe₂ are read as read data 62. That is to say, an unshaded portion of the storage data 61, namely data₀, data₁, and data₈ are read together with the parity data and the other data. In this regard, the kind of write-back in stripe₁ is “Bandwith”, and thus stripe₁ is not read.

And the write-back unit 35 determines whether disk read is normal or not (operation S87). If normal, the processing proceeds to operation S92. On the other hand, if not normal, the write-back unit 35 determines whether the suspected disk error has occurred or not (operation S88). As a result, in the case of an error other than the suspected disk, it is not possible to assure the data, thus the write-back unit 35 creates PIN data for the requested range (operation S89), and makes an abnormal response to the host 1 together with the PIN data (operation S90).

On the other hand, if the suspected disk error, the write-back unit 35 restores the data of the suspected disk from the other data and the parity data (operation S91). That is to say, the target area is an area into which the RAID apparatus 2 has written data in a state without redundancy, and thus the suspected disk might not store the latest data. Thus, the write-back unit 35 updates the data of the suspected disk to the latest data.

For example, in FIG. 12, in error occurred data 63, an error part 631 corresponding to the error-occurred LBA=0x10 in data₀ is restored from the corresponding parts 632, 633, and 634 in the other data₁ and data₂, which are used for parity generation, and parity₀. Specifically, the write-back unit 35 generates the data of the error part 631 by performing an exclusive-OR operation on the data of the corresponding part 632, 633, and 634 in data₁, data₂, and parity₀.

And the write-back unit 35 determines whether there is data consistency or not by performing compare check (operation S92). For example, in FIG. 12, a determination is made of whether all the bits of the result of performing exclusive-OR operation on data₀, data₁, data₂, and parity₀ are 0 or not.

As a result, if there is data consistency, the write-back unit 35 issues disk write (operation S96) in order to write update data into the disk. And the write-back unit 35 makes a normal response to the host 1 (operation S97).

On the other hand, if there is not data consistency, the write-back unit 35 restores the data of the suspected disk from the other data and the parity data in the same stripe, and updates the suspected disk (operation S93). For example, in FIG. 12, assuming that data inconsistency has been detected at LBA=0x20 of stripe₂, the write-back unit 35 determines the result of the exclusive-OR operation of parity₂, data₆, and data₇ in the restored old data 64 to be data₈.

And the write-back unit 35 issues disk write (operation S94), and writes the restored data and update data into the disk. For example, in FIG. 12, the kind of write-back for stripe₀ is “Small”, and data inconsistency has not been detected, and thus data₂ and parity₀ of the update data is written into the disk. Also, the kind of write-back for stripe₂ is “Readband”, and data inconsistency has been detected, thus data₈ of the suspected disk, and data₆, data₇, and parity₂ of the update data are written into the disk. And the write-back unit 35 makes a normal response to the host 1 (operation S95).

In this manner, if a write-back area is an area into which data write has been performed in a state in which the RAID apparatus 2 lost redundancy, by the write-back unit 35 performing matching processing of the suspected disk, it is possible for the RAID apparatus 2 to assure the data at higher level.

As described above, in the embodiment, when the RAID apparatus 2 becomes a failed state, the compulsory restore unit 33 determines whether the first disk and the last disk are restorable or not. If they are restorable, both of the disks are compulsorily restored. Accordingly, it is possible for the RAID apparatus 2 to have redundancy after RAID compulsory restore, and thus to improve data assurance.

Also, in the embodiment, when the RAID apparatus 2 writes data in a state without redundancy, the write-back unit 35 sets the corresponding bit to the data write area in slice_bitmap bits to “1”. And when the staging unit 34 reads data, the staging unit 34 determines whether the value of the corresponding bit to the data read area in slice_bitmap bits is “1” or not. If the bit is “1”, the staging unit 34 reads data for each stripe from the disk 221. And the staging unit 34 checks data consistency of the data for each stripe. If there is not consistency, the staging unit 34 restores the data of the suspected disk from the other data and the parity data. Also, when the write-back unit 35 writes data in the case where the kind of write-back is other than “Bandwidth”, the write-back unit 35 determines whether the value of the corresponding bit to the data write area in slice_bitmap bits is “1” or not. And if the bit is “1”, the write-back unit 35 reads the data from the disk 221 for each stripe. And the write-back unit 35 checks data consistency of the data for each stripe. If there is no consistency, the write-back unit 35 restores the data of the suspected disk from the other data and the parity data. Accordingly, it is possible for the RAID apparatus 2 to improve data consistency of the data, and data assurance.

In this regard, in the embodiment, a description has been mainly given of the case of RAIDS. However, the present disclosure is not limited to this, and for example, it is possible to apply the present disclosure to a RAID apparatus having redundancy, such as RAID1, RAID1+0, RAID6, and so on in the same manner. In the case of RAID6, if two disks fail, redundancy is lost. And by regarding these two disks as suspected disks, it is possible to apply the present disclosure in the same manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage apparatus including a plurality of storage devices, and a controller for controlling data read from the plurality of storage devices and data write to the plurality of storage devices,
the controller comprising:
when a new storage device has failed in a non-redundant state being a redundant group state without redundancy, in which some of the storage devices had failed out of the plurality of storage devices, a determination unit configured to determine whether execution of compulsory restore of the redundant group is possible or not on the basis of a failure cause of the plurality of failed storage devices; and
if the determination unit determines that the execution of compulsory restore of the redundant group is possible, a restore processing unit configured to incorporate a plurality of storage devices including a newly failed storage device in the non-redundant state into the redundant group and to compulsorily restore the storage apparatus to an available state.

2. The storage apparatus according to claim 1, further comprising
a reading and writing unit configured to store write information indicating a write area into a management information storage area at the time of writing data in the non-redundant state, and to read data from the storage device and write data to the storage device in a compulsory restore state being a state of having executed the compulsory restore on the basis of the write information.

3. The storage apparatus according to claim 2,
wherein the reading and writing unit determines whether data to be read is in an area written in the non-redundant state at the time of reading data from the storage device in the compulsory restore state on the basis of the write information, and if in the area written, the reading and writing unit reads data while performing update processing on the storage device having failed before the non-redundant state to latest data.

4. The storage apparatus according to claim 2,
wherein the reading and writing unit determines whether data read from the storage device is desired for generating parity data at the time of writing data into the storage device in the compulsory restore state, if determined that the data read is desired, the reading and writing unit determines whether data to be written is in an area written in the non-redundant state or not on the basis of the write information, and if in the area written, the reading and writing unit writes data while performing update processing on the storage device having failed before the non-redundant state to latest data.

5. The storage apparatus according to claim 3,
wherein the plurality of storage devices stores data and parity data created from the data for each stripe, and
the reading and writing unit reads data and parity data for all the stripes including data to be read and data to be written, and generates data of the storage device having failed before the non-redundant state from the data and the parity data read from the other device so as to update the data of the storage device to latest data.

6. A method of controlling in a storage apparatus including a plurality of storage devices, and a controller for controlling data read from the plurality of storage devices and data write to the plurality of storage devices, the method comprising:
the controller performing:
when a new storage device has failed in a non-redundant state being a redundant group state without redundancy, in which some of the storage devices had failed out of the plurality of storage devices, determining whether execution of compulsory restore of the redundant group is possible or not on the basis of a failure cause of the plurality of failed storage devices; and
if determined that the execution of compulsory restore of the redundant group is possible, incorporating a plurality of storage devices including a newly failed storage device in the non-redundant state into the redundant group and compulsorily restoring to an available state.

7. A computer-readable recording medium having stored therein a control program for causing a computer, the computer being in a storage apparatus including a plurality of storage devices, and a controller for controlling data read from the plurality of storage devices and data write to the plurality of storage devices, to execute a process for causing the computer to perform processing comprising:
when a new storage device has failed in a non-redundant state being a redundant group state without redundancy, in which some of the storage devices had failed out of the plurality of storage devices, determining whether execution of compulsory restore of the redundant group is possible or not on the basis of a failure cause of the plurality of failed storage devices; and
if determined that the execution of compulsory restore of the redundant group is possible, incorporating a plurality of storage devices including a newly failed storage device in the non-redundant state into the redundant group and compulsorily restoring to an available state.
